(19) United States
(12) Patent Application Publication
(10) Pub. No.: US 2024/0056837 A1
(43) Pub. Date: Feb. 15, 2024

(54) OPTIMIZED DATA STORAGE IN MOBILE NETWORK SCENARIOS

(71) Applicant: Nokia Solutions and Networks Oy, Espoo (FI)

(72) Inventors: Marie Line ALBERI-MOREL, Massy (FR); Alberto CONTE, Massy (FR); Fabio GIUST, Munich (DE); Soumeya KAADA, Massy (FR)

(21) Appl. No.: 18/447,715

(22) Filed: Aug. 10, 2023

(30) Foreign Application Priority Data
Aug. 10, 2022 (EP) 22189723.4

(51) Int. Cl. H04W 24/02

(52) U.S. Cl. CPC H04W 24/02

(57) ABSTRACT

There are provided measures for optimized data storage in mobile network scenarios. Such measures exemplarily comprise transmitting a data storage request requesting storage of data, said data storage request including conveyed information and an indicator indicative of a degree of involvement of generative models in said conveyed information which represents said data, and receiving a data storage acknowledge response.

### FIELD

Various example embodiments relate to optimized data storage in mobile network scenarios. More specifically, various example embodiments exemplarily relate to measures (including methods, apparatuses and computer program products) for realizing optimized data storage in mobile network scenarios.

### BACKGROUND

The present specification generally relates to mobile networks in which data (e.g. historical data) accumulate, are to be stored, and to be are to be retrieved.

With the increasing need in e.g. the 3^{rd} Generation Partnership Project (3GPP) 5^{th} Generation (5G) and beyond mobile networks e.g. to use artificial intelligence (AI)/machine learning (ML), a multiplicity of ML tasks will be executed, potentially leading to an explosion of amount of (historical) data to be stored. It will in general be important to save or limit resources for data storage while maintaining quality of the data stored.

With an analytics data repository function (ADRF) being the 5GC network function (NF) deputed to store historical data and analytics, it will be important for the ADRF to save or limit resources for historical data storage while maintaining quality of historical data stored.

This is limitation may be addressed by using techniques focusing on reducing the volume of data to be stored, by efficiently managing the data storage, by utilizing better existing storage hardware, or by utilizing storage equipment that consumes less energy.

Compression is a reduction in the number of bits needed to represent data. Reduction techniques can bring an acceptable trade-off between data quality, data quantity and resource saving or limiting for the ADRF. However, such approach may be accompanied with loss of data quality.

Hence, the problem arises that there are no approaches for handling an expected increase in data to be transmitted and stored without accompanying data loss or data quality loss.

Hence, there is a need to provide for optimized data storage in mobile network scenarios.

### SUMMARY

Various example embodiments aim at addressing at least part of the above issues and/or problems and drawbacks.

Various aspects of example embodiments are set out in the appended claims.

According to an exemplary aspect, there is provided a method comprising transmitting a data storage request requesting storage of data, said data storage request including conveyed information and an indicator indicative of a degree of involvement of generative models in said conveyed information which represents said data, and receiving a data storage acknowledge response.

According to an exemplary aspect, there is provided a method comprising receiving a data storage request requesting storage of data, said data storage request including conveyed information and an indicator indicative of a degree of involvement of generative models in said conveyed information which represents said data, storing said conveyed information, and transmitting a data storage acknowledge response.

According to an exemplary aspect, there is provided a method comprising transmitting a data retrieval request requesting data, said data retrieval request including an indicator indicative of a degree of involvement of generative models in information to be conveyed which represents said data, and receiving said information to be conveyed.

According to an exemplary aspect, there is provided a method comprising receiving a data retrieval request requesting data, said data retrieval request including an indicator indicative of a degree of involvement of generative models in information to be conveyed which represents said data, fetching said information to be conveyed based on said data retrieval request, and transmitting said information to be conveyed.

According to an exemplary aspect, there is provided an apparatus comprising transmitting circuitry configured to transmit a data storage request requesting storage of data, said data storage request including conveyed information and an indicator indicative of a degree of involvement of generative models in said conveyed information which represents said data, and receiving circuitry configured to receive a data storage acknowledge response.

According to an exemplary aspect, there is provided an apparatus comprising receiving circuitry configured to receive a data storage request requesting storage of data, said data storage request including conveyed information and an indicator indicative of a degree of involvement of generative models in said conveyed information which represents said data, storing circuitry configured to store said conveyed information, and transmitting circuitry configured to transmit a data storage acknowledge response.

According to an exemplary aspect, there is provided an apparatus comprising transmitting circuitry configured to transmit a data retrieval request requesting data, said data retrieval request including an indicator indicative of a degree of involvement of generative models in information to be conveyed which represents said data, and receiving circuitry configured to receive said information to be conveyed.

According to an exemplary aspect, there is provided an apparatus comprising receiving circuitry configured to receive a data retrieval request requesting data, said data retrieval request including an indicator indicative of a degree of involvement of generative models in information to be conveyed which represents said data, fetching circuitry configured to fetch said information to be conveyed based on said data retrieval request, and transmitting circuitry configured to transmit said information to be conveyed.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform transmitting a data storage request requesting storage of data, said data storage request including conveyed information and an indicator indicative of a degree of involvement of generative models in said conveyed information which represents said data, and receiving a data storage acknowledge response.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform receiving a data storage request requesting storage of data, said data storage request including conveyed information and an indicator indicative of a degree of involvement of generative models in said conveyed information which represents said data, storing said conveyed information, and transmitting a data storage acknowledge response.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform transmitting a data retrieval request requesting data, said data retrieval request including an indicator indicative of a degree of involvement of generative models in information to be conveyed which represents said data, and receiving said information to be conveyed.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform receiving a data retrieval request requesting data, said data retrieval request including an indicator indicative of a degree of involvement of generative models in information to be conveyed which represents said data, fetching said information to be conveyed based on said data retrieval request, and transmitting said information to be conveyed.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient and loss-less or at least loss-reduced storage, transmission, and re-use of data, to thereby solve at least part of the problems and drawbacks identified in relation to the prior art.

By way of example embodiments, there is provided optimized data storage in mobile network scenarios. More specifically, by way of example embodiments, there are provided measures and mechanisms for realizing optimized data storage in mobile network scenarios.

Thus, improvement is achieved by methods, apparatuses and computer program products enabling/realizing optimized data storage in mobile network scenarios.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a block diagram illustrating an apparatus according to example embodiments,

FIG. 6 is a block diagram illustrating an apparatus according to example embodiments,

FIG. 7 is a schematic diagram of a procedure according to example embodiments,

FIG. 8 is a schematic diagram of a procedure according to example embodiments,

FIG. 9 is a schematic diagram of a procedure according to example embodiments,

FIG. 10 is a schematic diagram of a procedure according to example embodiments,

FIG. 11 shows a schematic diagram of an example of a system environment,

FIG. 12 shows a schematic diagram of signaling sequences,

FIG. 13 shows a schematic diagram of an example of a generative adversarial network architecture,

FIG. 14 shows a schematic diagram of signaling sequences according to example embodiments,

FIG. 15 shows a schematic diagram of signaling sequences according to example embodiments,

FIG. 16 shows a schematic diagram of an example of a generative model descriptor scheme according to example embodiments,

FIG. 17 shows a schematic diagram of an example of a generative adversarial network generator model according to example embodiments, and

FIG. 18 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to example embodiments, in general terms, there are provided measures and mechanisms for (enabling/realizing) optimized data storage in mobile network scenarios.

Network data analytics function (NWDAF) is a 5G network function that collects data from 5G core (5GC) network functions, performs network analytics, ML-based inference, and provides insights with closed loop automation to authorized data consumers.

Located at core and edge, central and distributed NWDAF instances serve use cases which do not have real-time requirements and use cases which do have real-time, respectively. These are interfaced with functions such as a data and machine learning models repository for continuous training of AI/ML models.

The NWDAF may contain the following logical functions:
Analytics logical function (AnLF): A logical function in NWDAF, which performs inference, derives analytics information (i.e. derives statistics and/or predictions based on an analytics consumer request), and
Model training logical function (MTLF): A logical function in NWDAF, which trains ML models and exposes new training services (e.g. providing trained ML model).

As such, an NWDAF may perform
data collection based on subscription to events provided by AMF, SMF, PCF, UDM, NSACF, AF (directly or via NEF), and OAM,
analytics and data collection using a data collection coordination function (DCCF), and
storage and retrieval of information to/from an ADRF.

The 5G system (5GS) architecture allows ADRF to store and retrieve the collected data and/or analytics sent by the consumer. The following options are supported:
the ADRF exposes the Nadrf service for storage and retrieval of data by other 5GC NFs (e.g. NWDAF) which access the data using Nadrf services, and
the ADRF stores data received in an Nadrf_DataManagement_StorageRequest sent directly from an NF, or data received in an Ndccf_DataManagement_Notify from the DCCF or Nnwdaf_DataManagement_Notify from the NWDAF.

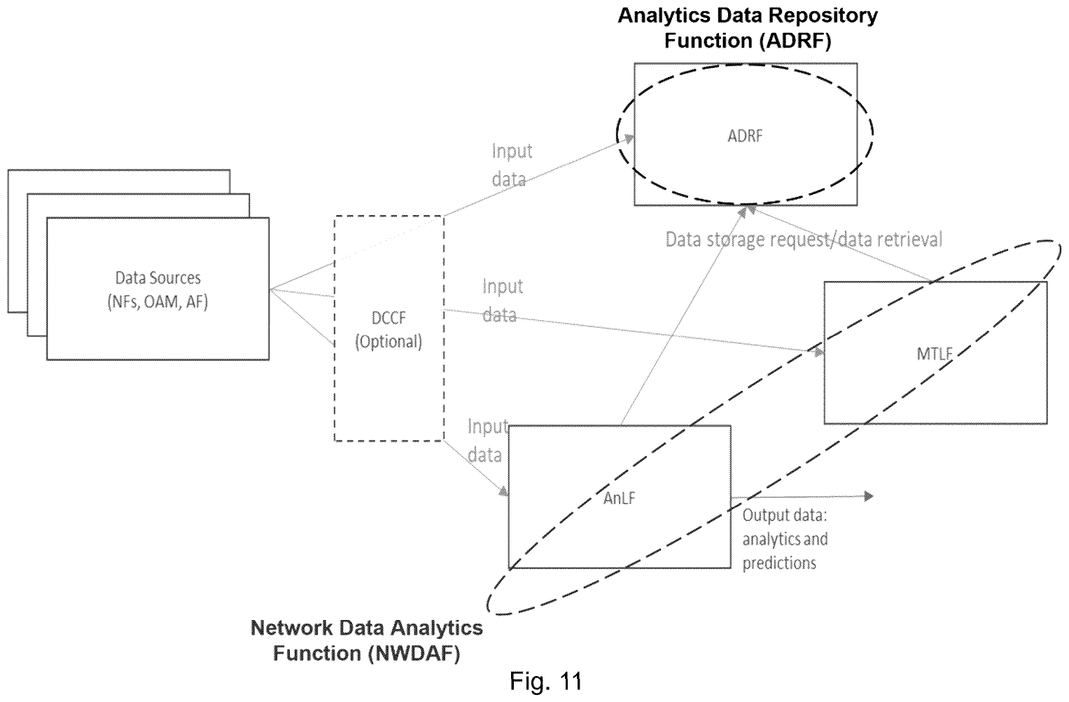

FIG. 11 shows a schematic diagram of an example of a system environment, and in particular illustrates an architecture of a connection between an NWDAF and an ADRF as discussed above.

Historical data is data related to a past time period. The period may be fixed by the parameter “Time Window” that is the start and stop time when the requested data or analytics was collected.

After a consumer obtains data and/or analytics, the consumer may store historical data and/or analytics in an ADRF.

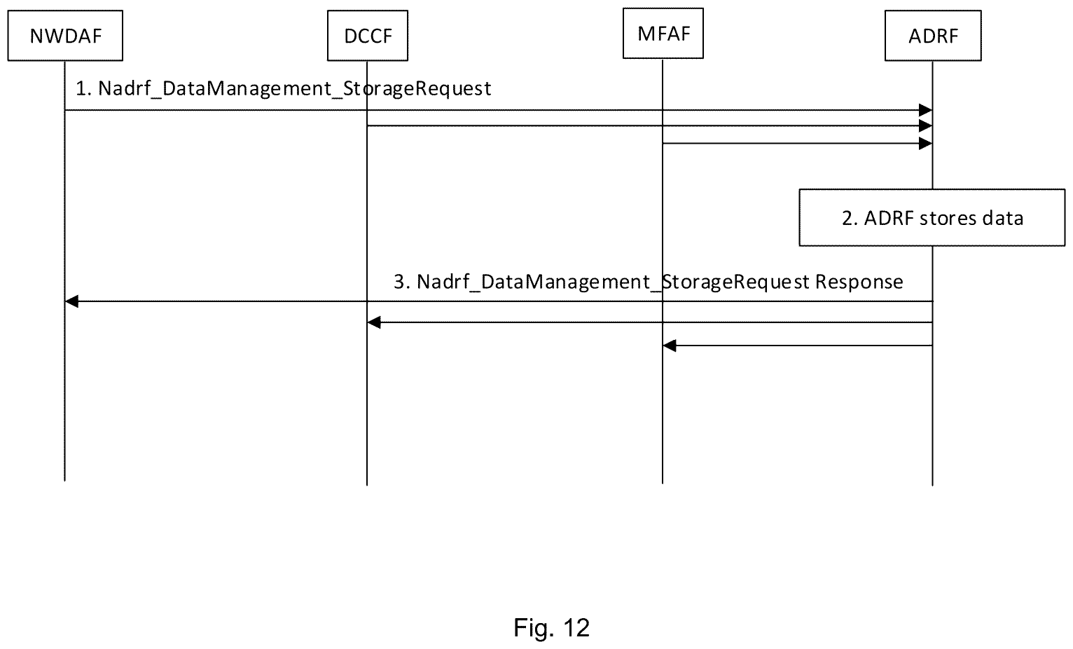

FIG. 12 shows a schematic diagram of signaling sequences, and in particular illustrates communication in relation to historical data and analytics storage.

The consumer may directly contact the ADRF or may go via the DCCF or via a messaging framework for storing the historical data and/or analytics in the ADRF.

In particular, the consumer may send data and/or analytics to the ADRF by invoking the Nadrf_DataManagement_StorageRequest (collected data, analytics, service operation, analytics specification or data specification and time window) service operation. The ADRF may, based on implementation, determine whether the same data and/or analytics is already stored or being stored based on the information sent by the consumer NF, and, if the data and/or analytics is already stored or being stored in the ADRF, the ADRF may decide not to store again the data and/or analytics sent by the consumer. The ADRF may send a Nadrf_DataManagement_StorageRequest response message to the consumer, indicating that data and/or analytics is stored, including when the ADRF may have determined that data or analytics is already stored. This process can also be done via notifications.

On the other hand, for a consumer it may be advantageous to retrieve historical data and/or analytics from an ADRF.

This may be used by data consumers (NWDAF, DCCF) to obtain historical data. Heretofore, the ADRF may be requested by the NWDAF or indirectly by DCCF to retrieve data.

In particular, the consumer may send a Nadrf_DataManagement_RetrievalRequest request to the ADRF to retrieve data or analytics for a specified data or analytics collection time window. The ADRF may determine the availability of the data or analytics in its repository and send a success/failure indication in the response to the consumer. If success, the ADRF may send in the response to the consumer either the data or analytics, or instructions for fetching the data or analytics using Nadrf_DataManagement_RetrievalNotify.

A consumer may also send a Nadrf_DataManagement_RetrievalSubscribe request to the ADRF to retrieve data or analytics for a specified data or analytics collection time window and to receive future notifications containing the corresponding data or analytics received by ADRF using Nadrf_DataManagement_RetrievalNotify. If the time window includes the future and the ADRF has subscribed to receive the data or analytics, subsequent notifications received by the ADRF are sent by the ADRF to the consumer. The Nadrf_DataManagement_RetrievalNotify service operation provides consumers with either data or analytics from an ADRF, or instructions to fetch the data or analytics from an ADRF.

5G-advanced is the step before 6^{th} Generation 6G which will open the door for pervasive AI and therefore, for many new ML-based services.

Thus, as mentioned above, with the increasing need in 5G and beyond mobile networks to use AI/ML, a multiplicity of ML tasks will be executed potentially leading to an explosion of collected data and thus, amount of historical data to be stored, and with the ADRF being the 5GC NF deputed to store historical data and analytics in 5G network, it will be important for it to save or limit resources for historical data storage while maintaining quality of historical data stored.

Hence, in brief, according to example embodiments, an NWDAF can use generative models (GM) to produce input data for inference and/or training, and the usage of the GM, and possibly the GM instance too, is included in the services exposed by ADRF, to reduce the volume of transferred and stored data.

GM is a deep learning-based tool to generate synthetic data that has the same statistical properties as the source data. By using GMs which size in amount of bit may be smaller than the size of a source data, the size of historical data stored can be significantly reduced.

Moreover, using GMs instead of raw data provides a higher flexibility, as e.g. ML tasks (such as those run by NWDAF) can locally generate an exact amount of data they need.

A data consumer may accept to use synthetic-data instead of real-data, for example for performing an initial model training.

GMs may address numerical, categorical, data, text.

Implicit distribution GMs as a generative adversarial network (GAN) are particularly referred to for example embodiments. Implicit distribution GMs as a GAN do not require an explicit definition for their model distribution. Instead, these models train themselves by indirectly sampling data from their parameterized distribution. In other words, implicit distribution GMs as a GAN do not require any information on data distribution to enable the generation of synthetic data which statistics are close to the data source statistics.

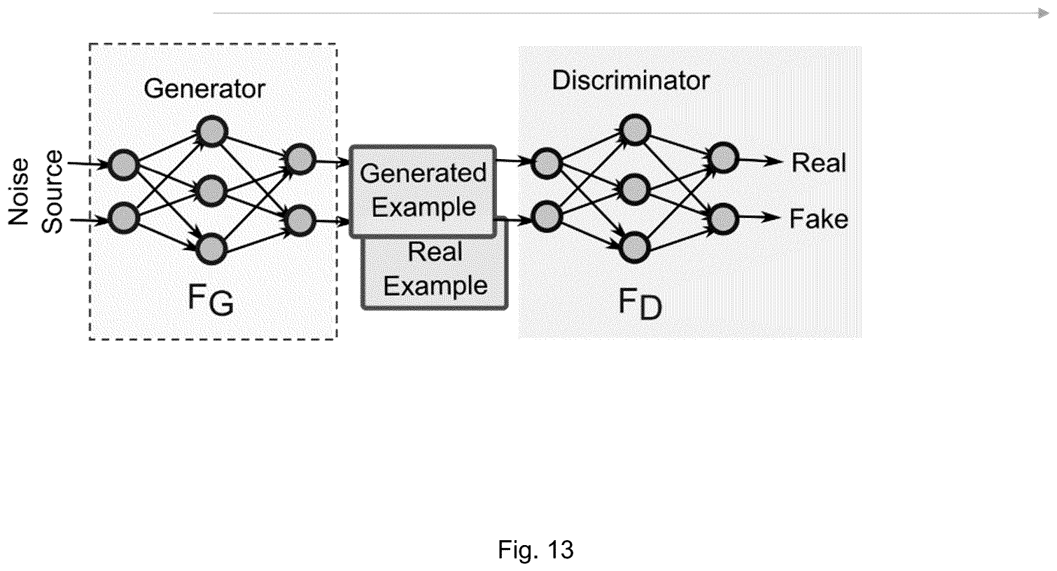

FIG. 13 shows a schematic diagram of an example of a GAN architecture.

GAN is a type of deep learning techniques. In the scope of generative models, GAN has emerged recently as a powerful tool for learning the probability and modelling complex data distribution. GAN is an unsupervised learning method for estimating density function via an adversarial process. GAN is capable of training in a completely unsupervised and unconditional fashion, meaning no labels are involved in the training process, and consequently, no process of label generation is required for operators that want to use them. This task is based on a combination of two adversarial models, a generator G and a discriminator D, that work together or simultaneously train. G and D models are neural networks with weight and bias parameters denoted as θ. G is used to generate data samples, while D tries to discriminate between real or fake data as seen in FIG. 13. From a simple noise source, the GAN technique is able to generate various data distributions while directly learning the joint distribution of multiple random variables.

By appropriately training the two models, it is possible to obtain a generator model that takes sampling vectors from random or targeted distribution as input and generates a sample in the problem domain as output. Thus, an opportunely trained generator model can generate data with a desired distribution. In the context of mobile networks this means data with same distribution of data collected from the network.

As mentioned above, according to example embodiments, an NWDAF can use generative models (GM) to produce input data for inference and/or training, and the usage of the GM, and possibly the GM instance too, is included in the services exposed by ADRF, to reduce the volume of transferred and stored data.

Considering this, according to example embodiments, historical data storage management is provided for NWDAF.

Namely, when a NWDAF makes a request to retrieve data from ADRF, according to example embodiments, the NWDAF indicates its capability to use GMs. Then, according to example embodiments, the ADRF provides the requested data along with a GM (GMs) and its descriptor for the NWDAF to use it to generate further data.

On the other hand, when the NWDAF requests the ADRF to store data, according to example embodiments, the NWDAF also indicates the GMs used and/or requests to store the GM. This way, less data can be stored by the ADRF, and when subsequent data retrieval requests are issued by NWDAFs for the same dataset, according to example embodiments, the ADRF sends the GM along with the stored data, which are expected to be significantly less than the data actually needed by the requesting NWDAF for its operations.

Summarizing, according to example embodiments, the ADRF is the data storage used by NWDAF to store and retrieve collected data and analytics for subsequent lookups/collections.

The collected data may come from the sources like Core, radio access network (RAN), from external like Core, operations, administration and maintenance (OAM) (e.g. performance management (PM), key performance indicators (KPI)), and from user equipments (UE) (e.g. in Rel-17).

Only data that is requested may be stored in ADRF.

According to example embodiments, the ADRF can use GMs to reduce the amount of data stored (i.e., at rest). Then, the GMs can be used to reduce the amount of data in transit in anticipation to explosion of historical data to be stored.

In particular, according to example embodiments, when an NWDAF retrieves data from an ADRF, the NWDAF
receives from the ADRF a portion of data plus the GM(s) and its(their) descriptor, and
learns from the GM descriptor how to use the GM(s) to generate synthetic data.

Further, according to example embodiments, when an NWDAF requests an ADRF to store data, the ADRF
receives from the NWDAF also an indicator related to a GM, implying that such NWDAF is able to execute that GM instance, and
uses the GM indication provided by the NWDAF to satisfy the next data retrieval requests coming from that NWDAF, i.e., to send data+GM.

Example embodiments are specified below in more detail.

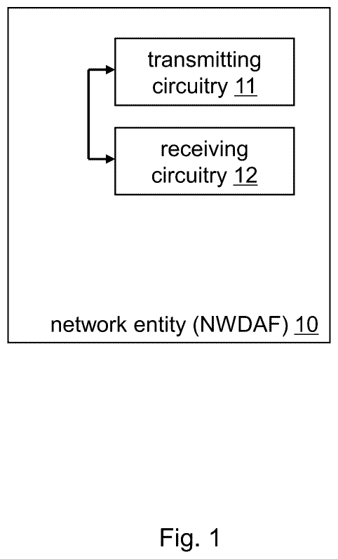

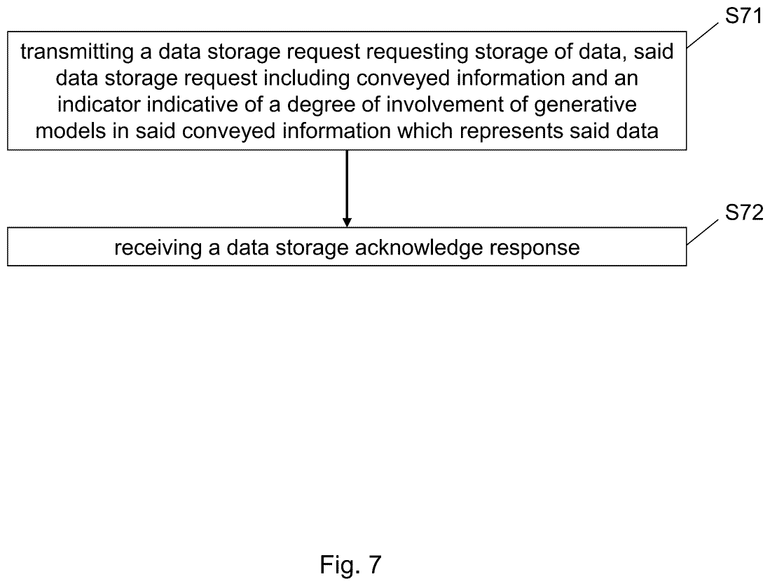

FIG. 1 is a block diagram illustrating an apparatus according to example embodiments. The apparatus may be a network node or entity 10 such as a network data analytics function (NWDAF) or a network node or entity 10 implementing an NWDAF, the apparatus comprising a transmitting circuitry 11 and a receiving circuitry 12. The transmitting circuitry 11 transmits a data storage request requesting storage of data, said data storage request including conveyed information and an indicator indicative of a degree of involvement of generative models in said conveyed information which represents said data. The receiving circuitry 12 receives a data storage acknowledge response. FIG. 7 is a schematic diagram of a procedure according to example embodiments. The apparatus according to FIG. 1 may perform the method of FIG. 7 but is not limited to this method. The method of FIG. 7 may be performed by the apparatus of FIG. 1 but is not limited to being performed by this apparatus.

As shown in FIG. 7, a procedure according to example embodiments comprises an operation of transmitting (S71) a data storage request requesting storage of data, said data storage request including conveyed information and an indicator indicative of a degree of involvement of generative models in said conveyed information which represents said data, and an operation of receiving (S72) a data storage acknowledge response.

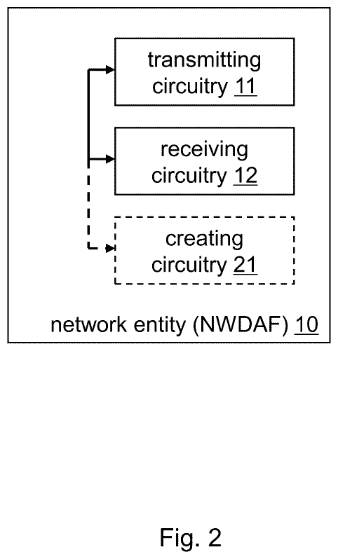

FIG. 2 is a block diagram illustrating an apparatus according to example embodiments. In particular, FIG. 2 illustrates a variation of the apparatus shown in FIG. 1. The apparatus according to FIG. 2 may thus further comprise a creating circuitry 21.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to further example embodiments, said indicator is indicative of that said conveyed information includes a full data set, and said conveyed information includes said full data set.

According to further example embodiments, said indicator is indicative of that said conveyed information includes a partial data set and at least one generative model configured to create a full data set based on said partial data set, and said conveyed information includes said partial data set and said at least one generative model.

According to further example embodiments, said indicator is indicative of that said conveyed information includes at least one generative model configured to create a full data set without reference to a part of said data set, and said conveyed information includes said at least one generative model.

According to further example embodiments, said conveyed information includes a generative model description specifying utilization of said at least one generative model.

According to a variation of the procedure shown in FIG. 7, exemplary additional operations are given, which are inherently independent from each other as such. According to such variation, an exemplary method according to example embodiments may comprise an operation of creating said data utilizing said at least one generative model.

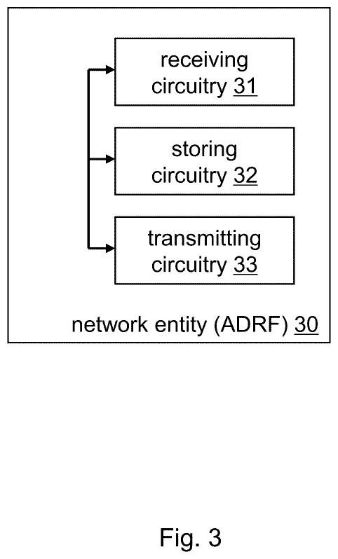

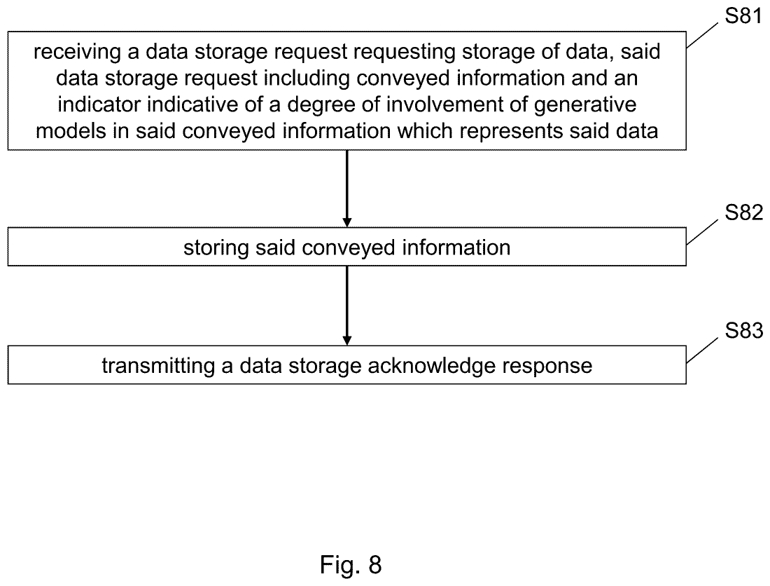

FIG. 3 is a block diagram illustrating an apparatus according to example embodiments. The apparatus may be a network node or entity 30 such as an analytics data repository function (ADRF) or a network node or entity 30 implementing an ADRF, the apparatus comprising a receiving circuitry 31, a storing circuitry 32, and a transmitting circuitry 33. The receiving circuitry 31 receives a data storage request requesting storage of data, said data storage request including conveyed information and an indicator indicative of a degree of involvement of generative models in said conveyed information which represents said data. The storing circuitry 32 stores said conveyed information. The transmitting circuitry 33 transmits a data storage acknowledge response. FIG. 8 is a schematic diagram of a procedure according to example embodiments. The apparatus according to FIG. 3 may perform the method of FIG. 8 but is not limited to this method. The method of FIG. 8 may be performed by the apparatus of FIG. 3 but is not limited to being performed by this apparatus.

As shown in FIG. 8, a procedure according to example embodiments comprises an operation of receiving (S81) a data storage request requesting storage of data, said data storage request including conveyed information and an indicator indicative of a degree of involvement of generative models in said conveyed information which represents said data, an operation of storing (S82) said conveyed information, and an operation of transmitting (S83) a data storage acknowledge response.

In an embodiment at least some of the functionalities of the apparatus shown in FIG. 3 may be shared between two physically separate devices forming one operational entity. Therefore, the apparatus may be seen to depict the operational entity comprising one or more physically separate devices for executing at least some of the described processes.

According to further example embodiments, said indicator is indicative of that said conveyed information includes a full data set, and said conveyed information includes said full data set.

According to further example embodiments, said indicator is indicative of that said conveyed information includes a partial data set and at least one generative model configured to create a full data set based on said partial data set, and said conveyed information includes said partial data set and said at least one generative model.

According to further example embodiments, said indicator is indicative of that said conveyed information includes at least one generative model configured to create a full data set without reference to a part of said data set, and said conveyed information includes said at least one generative model.

According to further example embodiments, said conveyed information includes a generative model description specifying utilization of said at least one generative model.

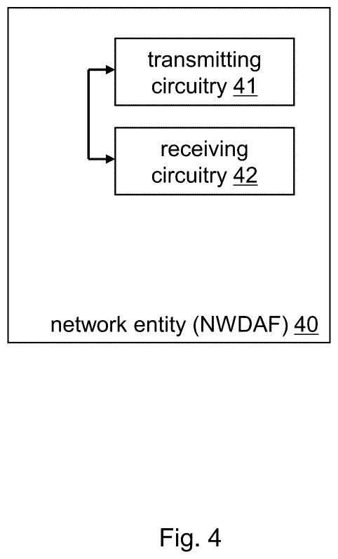

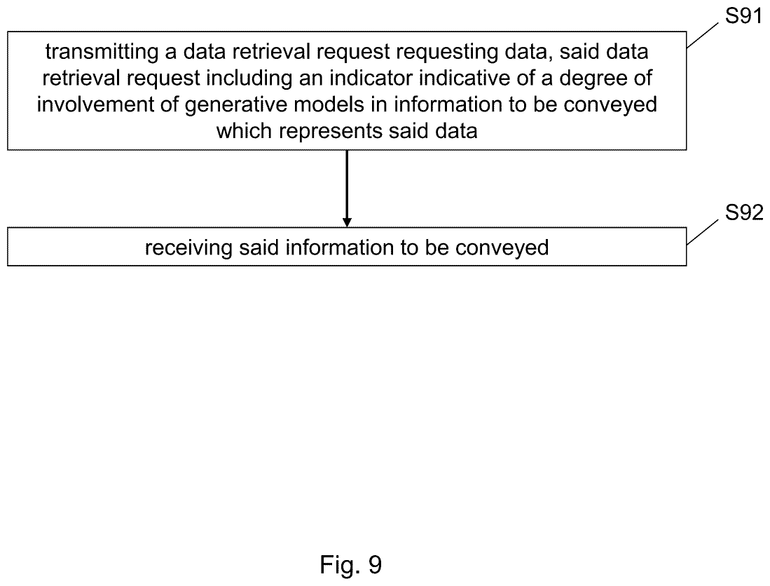

FIG. 4 is a block diagram illustrating an apparatus according to example embodiments. The apparatus may be a network node or entity 40 such as a network data analytics function (NWDAF) or a network node or entity 40 implementing an NWDAF, the apparatus comprising a transmitting circuitry 41 and a receiving circuitry 42. The transmitting circuitry 41 transmits a data retrieval request requesting data, said data retrieval request including an indicator indicative of a degree of involvement of generative models in information to be conveyed which represents said data. The receiving circuitry 42 receives said information to be conveyed. FIG. 9 is a schematic diagram of a procedure according to example embodiments. The apparatus according to FIG. 4 may perform the method of FIG. 9 but is not limited to this method. The method of FIG. 9 may be performed by the apparatus of FIG. 4 but is not limited to being performed by this apparatus.

As shown in FIG. 9, a procedure according to example embodiments comprises an operation of transmitting (S91) a data retrieval request requesting data, said data retrieval request including an indicator indicative of a degree of involvement of generative models in information to be conveyed which represents said data, and an operation of receiving (S92) said information to be conveyed.

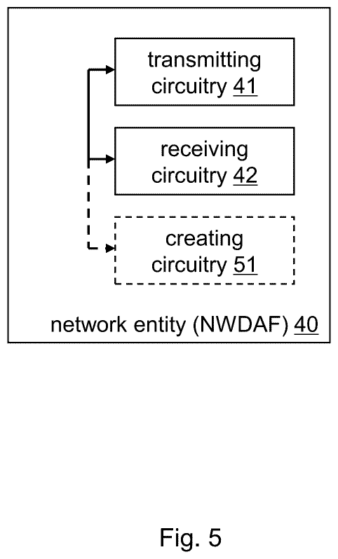

FIG. 5 is a block diagram illustrating an apparatus according to example embodiments. In particular, FIG. 5 illustrates a variation of the apparatus shown in FIG. 4. The apparatus according to FIG. 5 may thus further comprise a creating circuitry 51.

In an embodiment at least some of the functionalities of the apparatus shown in FIG. 4 (or 5) may be shared between two physically separate devices forming one operational entity. Therefore, the apparatus may be seen to depict the operational entity comprising one or more physically separate devices for executing at least some of the described processes.

According to further example embodiments, said indicator is indicative of that said information to be conveyed includes a full data set, and said information to be conveyed includes said full data set.

According to further example embodiments, said indicator is indicative of that said information to be conveyed includes a partial data set and at least one generative model configured to create a full data set based on said partial data set, and said information to be conveyed includes said partial data set and said at least one generative model.

According to further example embodiments, said indicator is indicative of that said information to be conveyed includes at least one generative model configured to create a full data set without reference to a part of said data set, and said information to be conveyed includes said at least one generative model.

According to further example embodiments, said information to be conveyed includes a generative model description specifying utilization of said at least one generative model.

According to further example embodiments, said data retrieval request includes a generative model support indicator indicating support of generative models for creation of data sets.

According to a variation of the procedure shown in FIG. 9, exemplary additional operations are given, which are inherently independent from each other as such. According to such variation, an exemplary method according to example embodiments may comprise an operation of creating said data utilizing said information to be conveyed.

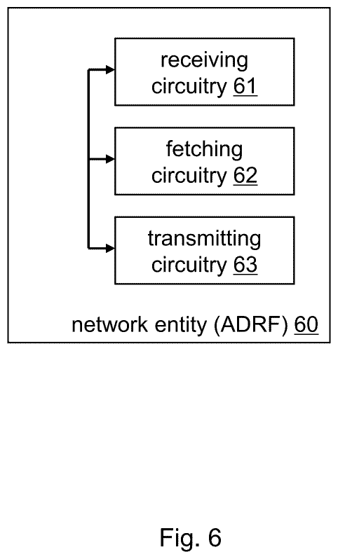

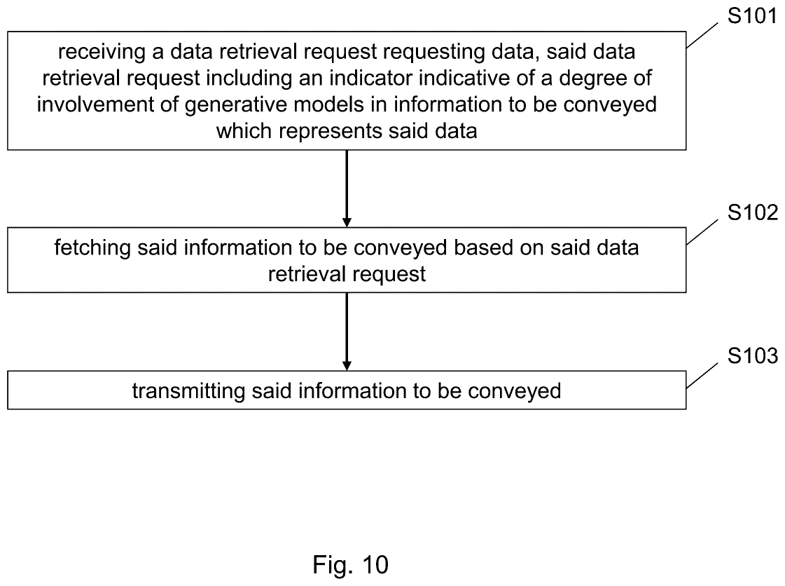

FIG. 6 is a block diagram illustrating an apparatus according to example embodiments. The apparatus may be a network node or entity 60 such as an analytics data repository function (ADRF) or a network node or entity 60 implementing an ADRF, the apparatus comprising a receiving circuitry 61, a fetching circuitry 62, and a transmitting circuitry 63. The receiving circuitry 61 receives a data retrieval request requesting data, said data retrieval request including an indicator indicative of a degree of involvement of generative models in information to be conveyed which represents said data. The fetching circuitry 62 fetches said information to be conveyed based on said data retrieval request. The transmitting circuitry 63 transmits said information to be conveyed. FIG. 10 is a schematic diagram of a procedure according to example embodiments. The apparatus according to FIG. 6 may perform the method of FIG. 10 but is not limited to this method. The method of FIG. 10 may be performed by the apparatus of FIG. 6 but is not limited to being performed by this apparatus.

As shown in FIG. 10, a procedure according to example embodiments comprises an operation of receiving (S101) a data retrieval request requesting data, said data retrieval request including an indicator indicative of a degree of involvement of generative models in information to be conveyed which represents said data, an operation of fetching (S102) said information to be conveyed based on said data retrieval request, and an operation of transmitting (S103) said information to be conveyed.

In an embodiment at least some of the functionalities of the apparatus shown in FIG. 6 may be shared between two physically separate devices forming one operational entity. Therefore, the apparatus may be seen to depict the operational entity comprising one or more physically separate devices for executing at least some of the described processes.

According to further example embodiments, said indicator is indicative of that said information to be conveyed includes a full data set, and said information to be conveyed includes said full data set.

According to further example embodiments, said indicator is indicative of that said information to be conveyed includes a partial data set and at least one generative model configured to create a full data set based on said partial data set, and said information to be conveyed includes said partial data set and said at least one generative model.

According to further example embodiments, said indicator is indicative of that said information to be conveyed includes at least one generative model configured to create a full data set without reference to a part of said data set, and said information to be conveyed includes said at least one generative model.

According to further example embodiments, said information to be conveyed includes a generative model description specifying utilization of said at least one generative model.

According to further example embodiments, said data retrieval request includes a generative model support indicator indicating support of generative models for creation of data sets.

Example embodiments outlined and specified above are explained below in more specific terms.

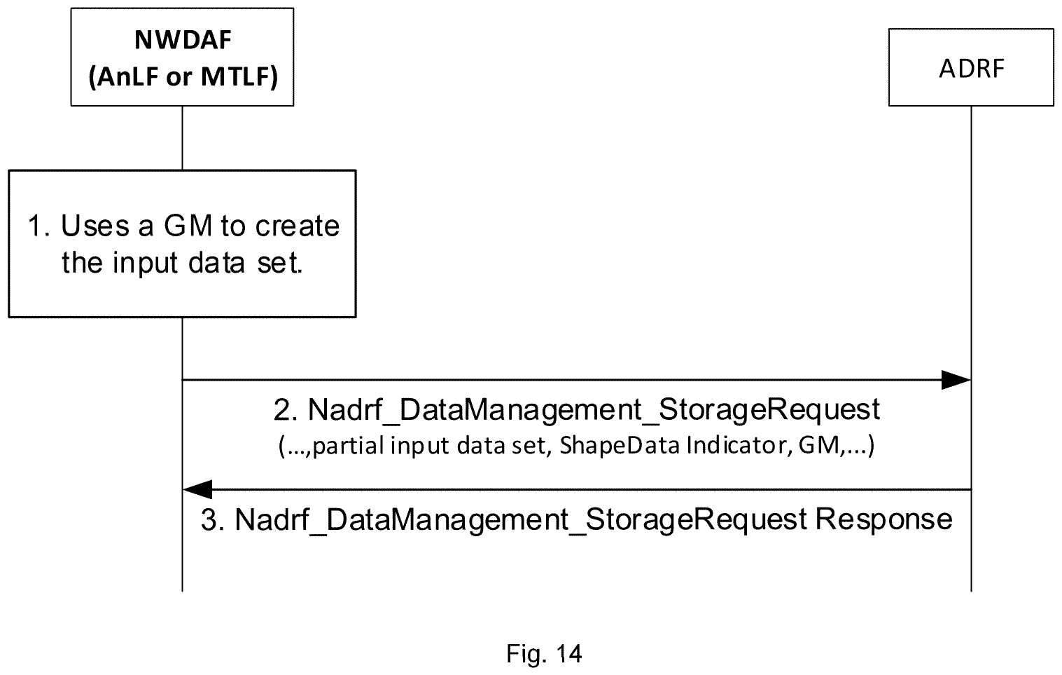

FIG. 14 shows a schematic diagram of signaling sequences according to example embodiments, and in particular illustrates a procedure according to which an NWDAF requests the ADRF to store historical data with a GM according to example embodiments.

Here, while FIG. 14 shows an example in which the NWDAF requests the ADRF to store a partial data set and the GM used to create the full dataset, example embodiments are not limited thereto, as specified above and explained further below.

In a step 1 of FIG. 14, according to example embodiments, the NWDAF uses a GM to create the input data set needed for its operations, i.e., analytics and/or training.

In a step 2 of FIG. 14, according to example embodiments, the NWDAF requests the ADRF to store partially the input data set, including a ShapeData indicator to inform that the data is synthetic along with the GM used to create the data set.

In a step 3 of FIG. 14, according to example embodiments, the ADRF sends a response to the NWDAF to acknowledge the operation.

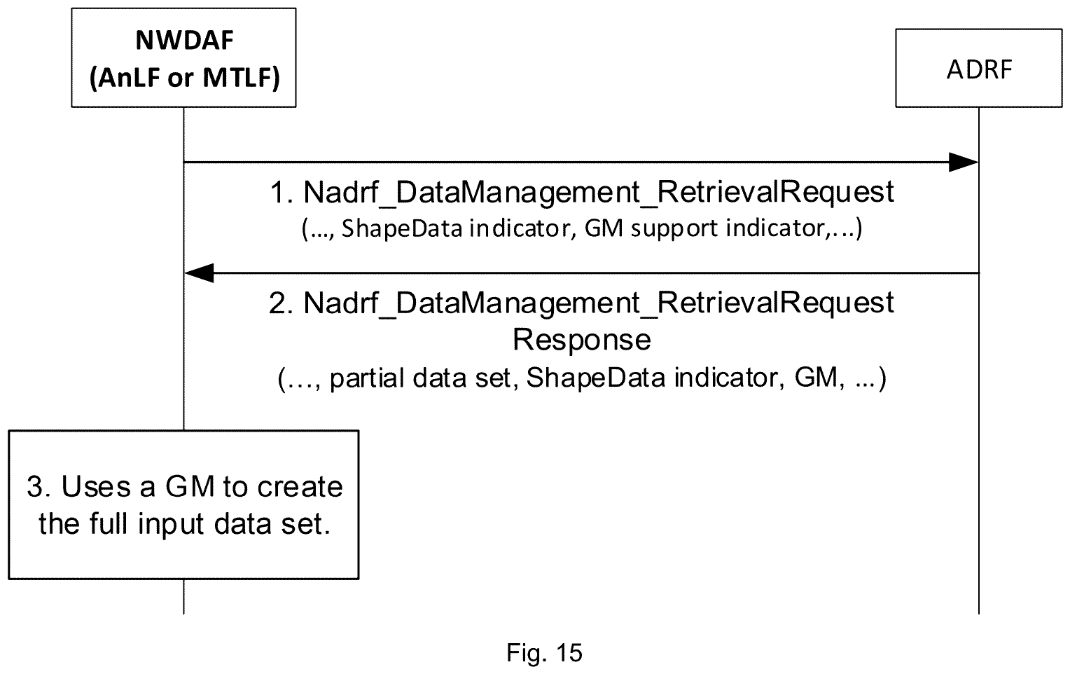

FIG. 15 shows a schematic diagram of signaling sequences according to example embodiments, and in particular illustrates a procedure according to which an NWDAF requests the ADRF to retrieve historical data with a GM according to example embodiments.

Here, while FIG. 15 shows an example in which the NWDAF retrieves from the ADRF a partial data set and the GM used to create the full dataset, example embodiments are not limited thereto, as specified above and explained further below.

In a step 1 of FIG. 15, according to example embodiments, the NWDAF sends a request to the ADRF in order to retrieve data, including a ShapeData indicator to inform that the data can be used to feed a GM, along with the GM support indicator.

In a step 2 of FIG. 15, according to example embodiments, the ADRF sends the requested data to the NWDAF, along with the supported GM.

In a step 3 of FIG. 15, according to example embodiments, the NWDAF uses the GM to create the input data set needed for its operations, i.e., analytics and/or training.

According to example embodiments, a GM can be created by a new logical function of an NWDAF, namely an MTLF dedicated to create GMs, referred to as generative model training logical function (GMTLF), which adds support to create GMs.

Further, according to example embodiments, a GM can be created by another NWDAF including only an MTLF dedicated to create GMs, which adds support to create GMs as well.

In both cases, signaling and specific exchanges are established between NWDAF and GMTLF.

An NWDAF according to example embodiments
supports to run GM(s) to create data sets,
adds the ShapeData and/or GM support indicators in the service operations, and
sends a GM and/or a GM descriptor to be stored.

An ADRF according to example embodiments
adds the ShapeData in the service operations, and
sends a GM or a GM descriptor to instruct/allow the NWDAF to generate data using the GM.

The ShapeData indicator (i.e., being an example for the indicator indicative of a degree of involvement of generative models in conveyed information/information to be conveyed) according to example embodiments is an indicator that informs whether the input data is sent
as full data set,
as partial data set and a GMs set (i.e., one or more generative models), or
as full GMs set (i.e., one or more generative models without the need for full/partial data).

According to example embodiments, the ShapeData indicator is a numerical value X. If X=“0”, then full data. If X=“1”, then partial data and GMs. If X=“2”, then full GMs set.

However, the ShapeData indicator is not limited to such type nor structure nor logical denotation.

The GM support indicator (i.e., being an example for the generative model support indicator indicating support of generative models for creation of data sets) according to example embodiments is an indicator that informs about support to run GM to create data sets.

The GM descriptor (i.e., being an example for the generative model description specifying utilization of said at least one generative model) according to example embodiments is a message/field that contains all information/metadata/overhead that fixes e.g the number of GMs, the architecture and model of GM (HyperParameters and training parameters) and an execution file (optional), e.g. Docker file (Image=libraries+file) or MLApp (application programming interface (API)).

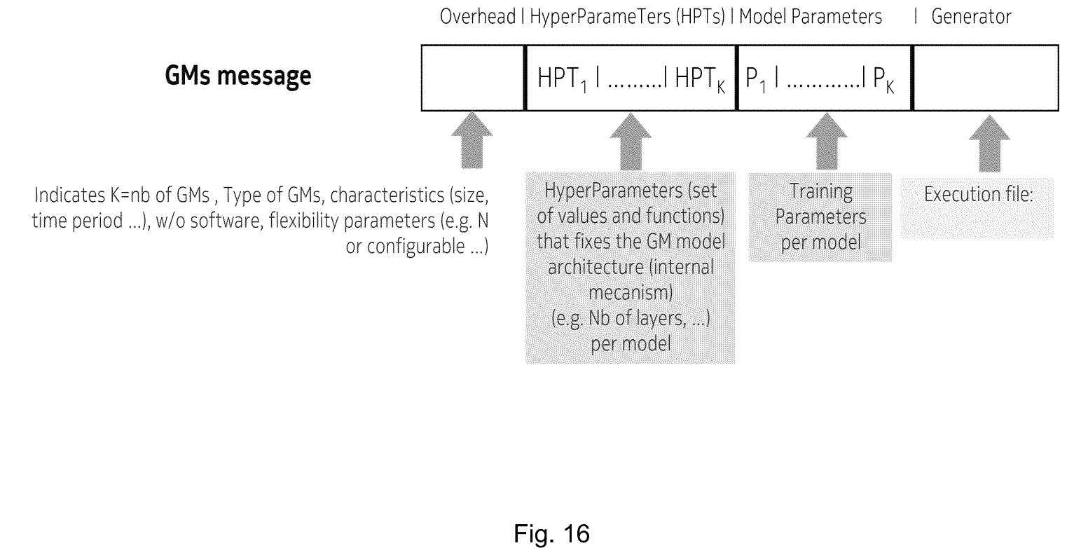

FIG. 16 shows a schematic diagram of an example of a generative model descriptor scheme according to example embodiments.

In case of GAN, according to example embodiments, only the generator model may be transferred. The generator model is comprises (1) HyperParameters, (2) Training Parameters, and (3) a Data Generation Execution file.

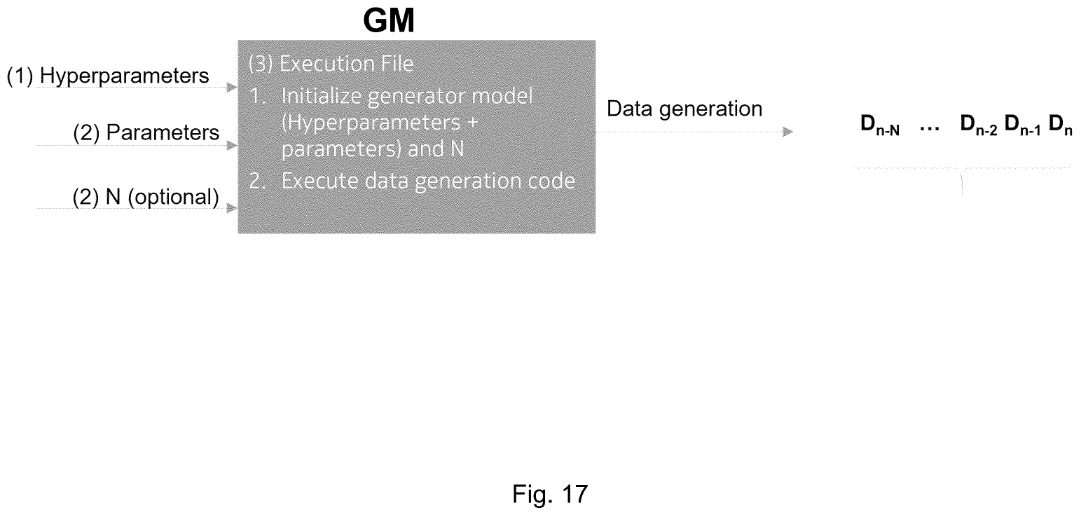

FIG. 17 shows a schematic diagram of an example of a generative adversarial network generator model according to example embodiments, and in particular illustrates a generator model entity of GAN, particularly a sequence of N+1 data, where N is the number of data that GM can generate.

According to example embodiments, advantageously, less data can be stored by the ADRF, i.e., less data can be necessary to be stored by the ADRF. In other words, the amount of historical data to store and to deliver in case of ML tasks multiplicity is limited.

Further, according to example embodiments, advantageously, enhancements can be provided for storage of data and/or analytics in ADRF, NWDAF and/or data source NF.

Still further, according to example embodiments, advantageously, enhancements can be provided to further reduce signaling and data traffic and the impact of obtaining data on data sources related to network analytics.

Fast and flexible access can be provided in particular for big historical data processing. For ML tasks (as MLTF or AnLF), local flexibility to generate an exact amount of data required can be provided. Further, for providers, control of the amount of data GMs can generate can be provided.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

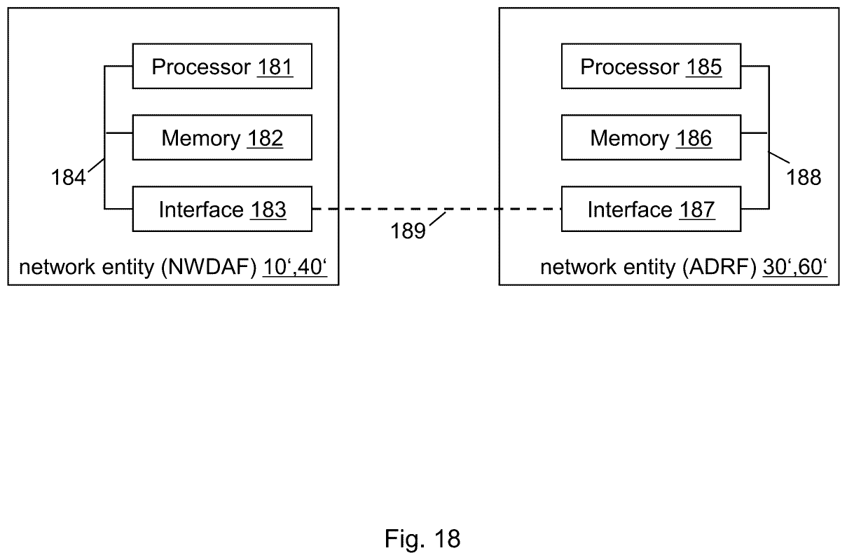

In FIG. 18, an alternative illustration of apparatuses according to example embodiments is depicted. As indicated in FIG. 18, according to example embodiments, the apparatus (network entity) 10′, 40′ (corresponding to the network entity 10, 40) comprises a processor 181, a memory 182 and an interface 183, which are connected by a bus 184 or the like. Further, the apparatus (network entity) 30′, 60′ (corresponding to the network entity 30, 60) comprises a processor 185, a memory 186 and an interface 187, which are connected by a bus 188 or the like. The apparatuses may be connected via link 189, respectively.

The processor 181/185 and/or the interface 183/187 may also include a modem or the like to facilitate communication over a (hardwire or wireless) link, respectively. The interface 183/187 may include a suitable transceiver coupled to one or more antennas or communication means for (hardwire or wireless) communications with the linked or connected device(s), respectively. The interface 183/187 is generally configured to communicate with at least one other apparatus, i.e. the interface thereof.

The memory 182/186 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the network entity 10 comprises at least one processor 181, at least one memory 182 including computer program code, and at least one interface 183 configured for communication with at least another apparatus. The processor (i.e. the at least one processor 181, with the at least one memory 182 and the computer program code) is configured to perform transmitting a data storage request requesting storage of data, said data storage request including conveyed information and an indicator indicative of a degree of involvement of generative models in said conveyed information which represents said data (thus the apparatus comprising corresponding means for transmitting), and to perform receiving a data storage acknowledge response (thus the apparatus comprising corresponding means for receiving).

According to example embodiments, an apparatus representing the network entity 30 comprises at least one processor 185, at least one memory 186 including computer program code, and at least one interface 187 configured for communication with at least another apparatus. The processor (i.e. the at least one processor 185, with the at least one memory 186 and the computer program code) is configured to perform receiving a data storage request requesting storage of data, said data storage request including conveyed information and an indicator indicative of a degree of involvement of generative models in said conveyed information which represents said data (thus the apparatus comprising corresponding means for receiving), to perform storing said conveyed information (thus the apparatus comprising corresponding means for storing), and to perform transmitting a data storage acknowledge response (thus the apparatus comprising corresponding means for transmitting).

According to example embodiments, an apparatus representing the network entity 40 comprises at least one processor 181, at least one memory 182 including computer program code, and at least one interface 183 configured for communication with at least another apparatus. The processor (i.e. the at least one processor 181, with the at least one memory 182 and the computer program code) is configured to perform transmitting a data retrieval request requesting data, said data retrieval request including an indicator indicative of a degree of involvement of generative models in information to be conveyed which represents said data (thus the apparatus comprising corresponding means for transmitting), and to perform receiving said information to be conveyed (thus the apparatus comprising corresponding means for receiving).

According to example embodiments, an apparatus representing the network entity 60 comprises at least one processor 185, at least one memory 186 including computer program code, and at least one interface 187 configured for communication with at least another apparatus. The processor (i.e. the at least one processor 185, with the at least one memory 186 and the computer program code) is configured to perform receiving a data retrieval request requesting data, said data retrieval request including an indicator indicative of a degree of involvement of generative models in information to be conveyed which represents said data (thus the apparatus comprising corresponding means for receiving), to perform fetching said information to be conveyed based on said data retrieval request (thus the apparatus comprising corresponding means for fetching), and to perform transmitting said information to be conveyed (thus the apparatus comprising corresponding means for transmitting).

For further details regarding the operability/functionality of the individual apparatuses, reference is made to the above description in connection with any one of FIGS. 1 to 17, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for optimized data storage in mobile network scenarios. Such measures exemplarily comprise transmitting a data storage request requesting storage of data, said data storage request including conveyed information and an indicator indicative of a degree of involvement of generative models in said conveyed information which represents said data, and receiving a data storage acknowledge response.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

Among others, following Items are disclosed by the above description and explanations:

Item 1. A method comprising
transmitting a data storage request requesting storage of data, said data storage request including conveyed information and an indicator indicative of a degree of involvement of generative models in said conveyed information which represents said data, and
receiving a data storage acknowledge response.

Item 2. The method according to Item 1, wherein
said indicator is indicative of that said conveyed information includes a full data set, and
said conveyed information includes said full data set.

Item 3. The method according to Item 1, wherein
said indicator is indicative of that said conveyed information includes a partial data set and at least one generative model configured to create a full data set based on said partial data set, and
said conveyed information includes said partial data set and said at least one generative model.

Item 4. The method according to Item 1, wherein
said indicator is indicative of that said conveyed information includes at least one generative model configured to create a full data set without reference to a part of said data set, and
said conveyed information includes said at least one generative model.

Item 5. The method according to Item 3 or 4, wherein
said conveyed information includes a generative model description specifying utilization of said at least one generative model.

Item 6. The method according to any of Items 1 to 5, further comprising
creating said data utilizing said at least one generative model.

Item 7. A method comprising
receiving a data storage request requesting storage of data, said data storage request including conveyed information and an indicator indicative of a degree of involvement of generative models in said conveyed information which represents said data,
storing said conveyed information, and
transmitting a data storage acknowledge response.

Item 8. The method according to Item 7, wherein
said indicator is indicative of that said conveyed information includes a full data set, and
said conveyed information includes said full data set.

Item 9. The method according to Item 7, wherein
said indicator is indicative of that said conveyed information includes a partial data set and at least one generative model configured to create a full data set based on said partial data set, and
said conveyed information includes said partial data set and said at least one generative model.

Item 10. The method according to Item 7, wherein
said indicator is indicative of that said conveyed information includes at least one generative model configured to create a full data set without reference to a part of said data set, and
said conveyed information includes said at least one generative model.

Item 11. The method according to Item 9 or 10, wherein
said conveyed information includes a generative model description specifying utilization of said at least one generative model.

Item 12. A method comprising
transmitting a data retrieval request requesting data, said data retrieval request including an indicator indicative of a degree of involvement of generative models in information to be conveyed which represents said data, and
receiving said information to be conveyed.

Item 13. The method according to Item 12, wherein
said indicator is indicative of that said information to be conveyed includes a full data set, and
said information to be conveyed includes said full data set.

Item 14. The method according to Item 12, wherein
said indicator is indicative of that said information to be conveyed includes a partial data set and at least one generative model configured to create a full data set based on said partial data set, and
said information to be conveyed includes said partial data set and said at least one generative model.

Item 15. The method according to Item 12, wherein
said indicator is indicative of that said information to be conveyed includes at least one generative model configured to create a full data set without reference to a part of said data set, and
said information to be conveyed includes said at least one generative model.

Item The method according to Item 14 or 15, wherein
said information to be conveyed includes a generative model description specifying utilization of said at least one generative model.

Item 17. The method according to any of Items 12 to 16, wherein
said data retrieval request includes a generative model support indicator indicating support of generative models for creation of data sets.

Item 18. The method according to any of Items 12 to 17, further comprising
creating said data utilizing said information to be conveyed.

Item 19. A method comprising
receiving a data retrieval request requesting data, said data retrieval request including an indicator indicative of a degree of involvement of generative models in information to be conveyed which represents said data,
fetching said information to be conveyed based on said data retrieval request, and
transmitting said information to be conveyed.

Item 20. The method according to Item 19, wherein
said indicator is indicative of that said information to be conveyed includes a full data set, and
said information to be conveyed includes said full data set.

Item 21. The method according to Item 19, wherein
said indicator is indicative of that said information to be conveyed includes a partial data set and at least one generative model configured to create a full data set based on said partial data set, and
said information to be conveyed includes said partial data set and said at least one generative model.

Item 22. The method according to Item 19, wherein
said indicator is indicative of that said information to be conveyed includes at least one generative model configured to create a full data set without reference to a part of said data set, and
said information to be conveyed includes said at least one generative model.

Item 23. The method according to Item 21 or 22, wherein
said information to be conveyed includes a generative model description specifying utilization of said at least one generative model.

Item 24. The method according to any of Items 19 to 23, wherein
said data retrieval request includes a generative model support indicator indicating support of generative models for creation of data sets.

Item 25. An apparatus comprising
transmitting circuitry configured to transmit a data storage request requesting storage of data, said data storage request including conveyed information and an indicator indicative of a degree of involvement of generative models in said conveyed information which represents said data, and
receiving circuitry configured to receive a data storage acknowledge response.

Item 26. The apparatus according to Item 25, wherein
said indicator is indicative of that said conveyed information includes a full data set, and
said conveyed information includes said full data set.

Item 27. The apparatus according to Item 25, wherein
said indicator is indicative of that said conveyed information includes a partial data set and at least one generative model configured to create a full data set based on said partial data set, and
said conveyed information includes said partial data set and said at least one generative model.

Item 28. The apparatus according to Item 25, wherein
said indicator is indicative of that said conveyed information includes at least one generative model configured to create a full data set without reference to a part of said data set, and
said conveyed information includes said at least one generative model.

Item 29. The apparatus according to Item 27 or 28, wherein
said conveyed information includes a generative model description specifying utilization of said at least one generative model.

Item 30. The apparatus according to any of Items 25 to 29, further comprising
creating circuitry configured to create said data utilizing said at least one generative model.

Item 31. An apparatus comprising
receiving circuitry configured to receive a data storage request requesting storage of data, said data storage request including conveyed information and an indicator indicative of a degree of involvement of generative models in said conveyed information which represents said data,
storing circuitry configured to store said conveyed information, and
transmitting circuitry configured to transmit a data storage acknowledge response.

Item 32. The apparatus according to Item 31, wherein
said indicator is indicative of that said conveyed information includes a full data set, and
said conveyed information includes said full data set.

Item 33. The apparatus according to Item 31, wherein
said indicator is indicative of that said conveyed information includes a partial data set and at least one generative model configured to create a full data set based on said partial data set, and
said conveyed information includes said partial data set and said at least one generative model.

Item 34. The apparatus according to Item 31, wherein
said indicator is indicative of that said conveyed information includes at least one generative model configured to create a full data set without reference to a part of said data set, and
said conveyed information includes said at least one generative model.

Item 35. The apparatus according to Item 33 or 34, wherein
said conveyed information includes a generative model description specifying utilization of said at least one generative model.

Item 36. An apparatus comprising
transmitting circuitry configured to transmit a data retrieval request requesting data, said data retrieval request including an indicator indicative of a degree of involvement of generative models in information to be conveyed which represents said data, and
receiving circuitry configured to receive said information to be conveyed.

Item 37. The apparatus according to Item 36, wherein
said indicator is indicative of that said information to be conveyed includes a full data set, and
said information to be conveyed includes said full data set.

Item 38. The apparatus according to Item 36, wherein
said indicator is indicative of that said information to be conveyed includes a partial data set and at least one generative model configured to create a full data set based on said partial data set, and
said information to be conveyed includes said partial data set and said at least one generative model.

Item 39. The apparatus according to Item 36, wherein
said indicator is indicative of that said information to be conveyed includes at least one generative model configured to create a full data set without reference to a part of said data set, and
said information to be conveyed includes said at least one generative model.

Item 40. The apparatus according to Item 38 or 39, wherein
said information to be conveyed includes a generative model description specifying utilization of said at least one generative model.

Item 41. The apparatus according to any of Items 36 to 40, wherein
said data retrieval request includes a generative model support indicator indicating support of generative models for creation of data sets.

Item 42. The apparatus according to any of Items 36 to 41, further comprising
creating circuitry configured to create said data utilizing said information to be conveyed.

Item 43. An apparatus comprising
receiving circuitry configured to receive a data retrieval request requesting data, said data retrieval request including an indicator indicative of a degree of involvement of generative models in information to be conveyed which represents said data,
fetching circuitry configured to fetch said information to be conveyed based on said data retrieval request, and
transmitting circuitry configured to transmit said information to be conveyed.

Item 44. The apparatus according to Item 43, wherein
said indicator is indicative of that said information to be conveyed includes a full data set, and
said information to be conveyed includes said full data set.

Item 45. The apparatus according to Item 43, wherein
said indicator is indicative of that said information to be conveyed includes a partial data set and at least one generative model configured to create a full data set based on said partial data set, and
said information to be conveyed includes said partial data set and said at least one generative model.

Item 46. The apparatus according to Item 43, wherein
said indicator is indicative of that said information to be conveyed includes at least one generative model configured to create a full data set without reference to a part of said data set, and
said information to be conveyed includes said at least one generative model.

Item 47. The apparatus according to Item 45 or 46, wherein
said information to be conveyed includes a generative model description specifying utilization of said at least one generative model.

Item 48. The apparatus according to any of Items 43 to 47, wherein
said data retrieval request includes a generative model support indicator indicating support of generative models for creation of data sets.

Item 49. An apparatus comprising
at least one processor,
at least one memory including computer program code, and
at least one interface configured for communication with at least another apparatus,
the at least one processor, with the at least one memory and the computer program code, being configured to cause the apparatus to perform:
transmitting a data storage request requesting storage of data, said data storage request including conveyed information and an indicator indicative of a degree of involvement of generative models in said conveyed information which represents said data, and
receiving a data storage acknowledge response.

Item 50. The apparatus according to Item 49, wherein
said indicator is indicative of that said conveyed information includes a full data set, and
said conveyed information includes said full data set.

Item 51. The apparatus according to Item 49, wherein
said indicator is indicative of that said conveyed information includes a partial data set and at least one generative model configured to create a full data set based on said partial data set, and
said conveyed information includes said partial data set and said at least one generative model.

Item 52. The apparatus according to Item 49, wherein
said indicator is indicative of that said conveyed information includes at least one generative model configured to create a full data set without reference to a part of said data set, and
said conveyed information includes said at least one generative model.

Item 53. The apparatus according to Item 51 or 52, wherein
said conveyed information includes a generative model description specifying utilization of said at least one generative model.

Item 54. The apparatus according to any of Items 49 to 53, wherein
the at least one processor, with the at least one memory and the computer program code, being configured to cause the apparatus to perform:
creating said data utilizing said at least one generative model.

Item 55. An apparatus comprising
at least one processor,
at least one memory including computer program code, and
at least one interface configured for communication with at least another apparatus,
the at least one processor, with the at least one memory and the computer program code, being configured to cause the apparatus to perform:
receiving a data storage request requesting storage of data, said data storage request including conveyed information and an indicator indicative of a degree of involvement of generative models in said conveyed information which represents said data,
storing said conveyed information, and
transmitting a data storage acknowledge response.

Item 56. The apparatus according to Item 55, wherein
said indicator is indicative of that said conveyed information includes a full data set, and
said conveyed information includes said full data set.

Item 57. The apparatus according to Item 55, wherein
said indicator is indicative of that said conveyed information includes a partial data set and at least one generative model configured to create a full data set based on said partial data set, and
said conveyed information includes said partial data set and said at least one generative model.

Item 58. The apparatus according to Item 55, wherein
said indicator is indicative of that said conveyed information includes at least one generative model configured to create a full data set without reference to a part of said data set, and
said conveyed information includes said at least one generative model.

Item 59. The apparatus according to Item 57 or 58, wherein
said conveyed information includes a generative model description specifying utilization of said at least one generative model.

Item 60. An apparatus comprising
at least one processor,
at least one memory including computer program code, and
at least one interface configured for communication with at least another apparatus,
the at least one processor, with the at least one memory and the computer program code, being configured to cause the apparatus to perform:
transmitting a data retrieval request requesting data, said data retrieval request including an indicator indicative of a degree of involvement of generative models in information to be conveyed which represents said data, and
receiving said information to be conveyed.

Item 61. The apparatus according to Item 60, wherein
said indicator is indicative of that said information to be conveyed includes a full data set, and
said information to be conveyed includes said full data set.

Item 62. The apparatus according to Item 60, wherein
said indicator is indicative of that said information to be conveyed includes a partial data set and at least one generative model configured to create a full data set based on said partial data set, and
said information to be conveyed includes said partial data set and said at least one generative model.

Item 63. The apparatus according to Item 60, wherein
said indicator is indicative of that said information to be conveyed includes at least one generative model configured to create a full data set without reference to a part of said data set, and
said information to be conveyed includes said at least one generative model.

Item 64. The apparatus according to Item 62 or 63, wherein
said information to be conveyed includes a generative model description specifying utilization of said at least one generative model.

Item 65. The apparatus according to any of Items 60 to 64, wherein
said data retrieval request includes a generative model support indicator indicating support of generative models for creation of data sets.

Item 66. The apparatus according to any of Items 60 to 65, wherein
the at least one processor, with the at least one memory and the computer program code, being configured to cause the apparatus to perform:
creating said data utilizing said information to be conveyed.

Item 67. An apparatus comprising
at least one processor,
at least one memory including computer program code, and
at least one interface configured for communication with at least another apparatus,
the at least one processor, with the at least one memory and the computer program code, being configured to cause the apparatus to perform:
receiving a data retrieval request requesting data, said data retrieval request including an indicator indicative of a degree of involvement of generative models in information to be conveyed which represents said data,
fetching said information to be conveyed based on said data retrieval request, and
transmitting said information to be conveyed.

Item 68. The apparatus according to Item 67, wherein
said indicator is indicative of that said information to be conveyed includes a full data set, and
said information to be conveyed includes said full data set.

Item 69. The apparatus according to Item 67, wherein
said indicator is indicative of that said information to be conveyed includes a partial data set and at least one generative model configured to create a full data set based on said partial data set, and
said information to be conveyed includes said partial data set and said at least one generative model.

Item 70. The apparatus according to Item 67, wherein
said indicator is indicative of that said information to be conveyed includes at least one generative model configured to create a full data set without reference to a part of said data set, and
said information to be conveyed includes said at least one generative model.

Item 71. The apparatus according to Item 69 or 70, wherein
said information to be conveyed includes a generative model description specifying utilization of said at least one generative model.

Item 72. The apparatus according to any of Items 67 to 71, wherein
said data retrieval request includes a generative model support indicator indicating support of generative models for creation of data sets.

Item 73. A computer program product comprising computer-executable computer program code which, when the program is run on a computer, is configured to cause the computer to carry out the method according to any one of Items 1 to 6, 7 to 11, 12 to 18, or 19 to 24.

Item 74. The computer program product according to Item 73, wherein the computer program product comprises a computer-readable medium on which the computer-executable computer program code is stored, and/or wherein the program is directly loadable into an internal memory of the computer or a processor thereof.

### LIST OF ACRONYMS AND ABBREVIATIONS

### 3GPP 3rd Generation Partnership Project

### 5G 5th Generation

5GC 5G core
5GS 5G system
ADRF analytics data repository function
AI artificial intelligence
AnLF analytics logical function
API application programming interface
DCCF data collection coordination function
GAN generative adversarial network
GM generative model
GMTLF generative model training logical function
KPI key performance indicator
ML machine learning
MTLF model training logical function
NF network function
NWDAF network data analytics function
OAM operations, administration and maintenance
PM performance management
RAN radio access network
UE user equipment

1. An apparatus comprising
at least one processor, and
at least one memory including computer program code, and
at least one interface for communication with at least another apparatus,
the at least one processor, with the at least one memory and computer program code,
being configured to cause the apparatus to:
transmit a data storage request requesting storage of data, said data storage request including conveyed information and an indicator indicative of a degree of involvement of generative models in said conveyed information which represents said data, and
receive a data storage acknowledge response.

2. The apparatus according to claim 1,
wherein said indicator is indicative of that said conveyed information includes a full data set, and
said conveyed information includes said full data set.

3. The apparatus according to claim 1,
wherein said indicator is indicative of that said conveyed information includes a partial data set and at least one generative model configured to create a full data set based on said partial data set, and
said conveyed information includes said partial data set and said at least one generative model.

4. The apparatus according to claim 1,
wherein said indicator is indicative of that said conveyed information includes at least one generative model configured to create a full data set without reference to a part of said data set, and
said conveyed information includes said at least one generative model.

5. The apparatus according to claim 3,
wherein said conveyed information includes a generative model description specifying utilization of said at least one generative model.

6. The apparatus according to claim 1, wherein the apparatus is further caused to:
create said data utilizing said at least one generative model.

7. An apparatus comprising
at least one processor, and
at least one memory including computer program code, and
at least one interface for communication with at least another apparatus,
the at least one processor, with the at least one memory and computer program code,
being configured to cause the apparatus to:
receive a data storage request requesting storage of data, said data storage request including conveyed information and an indicator indicative of a degree of involvement of generative models in said conveyed information which represents said data,
store said conveyed information, and
transmit a data storage acknowledge response.

8. The apparatus according to claim 7,
wherein said indicator is indicative of that said conveyed information includes a full data set, and
said conveyed information includes said full data set.

9. The apparatus according to claim 7,
wherein said indicator is indicative of that said conveyed information includes a partial data set and at least one generative model configured to create a full data set based on said partial data set, and
said conveyed information includes said partial data set and said at least one generative model.

10. An apparatus comprising
at least one processor, and
at least one memory including computer program code, and
at least one interface for communication with at least another apparatus,
the at least one processor, with the at least one memory and computer program code,
being configured to cause the apparatus to:
transmit a data retrieval request requesting data, said data retrieval request including an indicator indicative of a degree of involvement of generative models in information to be conveyed which represents said data, and
received said information to be conveyed.

11. The apparatus according to claim 10,
wherein said indicator is indicative of that said information to be conveyed includes a full data set, and
said information to be conveyed includes said full data set.

12. The apparatus according to claim 10,
wherein said indicator is indicative of that said information to be conveyed includes a partial data set and at least one generative model configured to create a full data set based on said partial data set, and
said information to be conveyed includes said partial data set and said at least one generative model.

13. The apparatus according to claim 10,
wherein said indicator is indicative of that said information to be conveyed includes at least one generative model configured to create a full data set without reference to a part of said data set, and
said information to be conveyed includes said at least one generative model.

14. The apparatus according to claim 12,
wherein said information to be conveyed includes a generative model description specifying utilization of said at least one generative model.

15. The apparatus according to claim 10,
wherein said data retrieval request includes a generative model support indicator indicating support of generative models for creation of data sets.

16. The apparatus according to claim 10, wherein the apparatus is further caused to:
create said data utilizing said information to be conveyed.

17. An apparatus comprising
at least one processor, and
at least one memory including computer program code, and
at least one interface for communication with at least another apparatus,
the at least one processor, with the at least one memory and computer program code,
being configured to cause the apparatus to:
receive a data retrieval request requesting data, said data retrieval request including an indicator indicative of a degree of involvement of generative models in information to be conveyed which represents said data,
fetch said information to be conveyed based on said data retrieval request, and
transmit said information to be conveyed.

18. The apparatus according to claim 17,
wherein said indicator is indicative of that said conveyed information includes a full data set, and
said conveyed information includes said full data set.

19. The apparatus according to claim 17,
wherein said indicator is indicative of that said conveyed information includes a partial data set and at least one generative model configured to create a full data set based on said partial data set, and
said conveyed information includes said partial data set and said at least one generative model.

20. The apparatus according to claim 17,
wherein said indicator is indicative of that said information to be conveyed includes at least one generative model configured to create a full data set without reference to a part of said data set, and
said information to be conveyed includes said at least one generative model.
